(19) United States
(12) Patent Application Publication
(10) Pub. No.: US 2026/0327825 A1
(43) Pub. Date: Oct. 22, 2026

(54) SYSTEMS AND METHODS FOR ELECTROLYTIC SYNGAS PRODUCTION

(71) Applicant: Georgia Tech Research Corporation, Atlanta, GA (US)

(72) Inventors: Marta Hatzell, Atlanta, GA (US); Hakhyeon Song, Atlanta, GA (US); Po-Wei Huang, Atlanta, GA (US)

(21) Appl. No.: 19/652,696

(22) Filed: Apr. 20, 2026

Related U.S. Application Data
(60) Provisional application No. 63/791,029, filed on Apr. 18, 2025.

(51) Int. Cl. C25B 11/036; C25B 1/23; C25B 11/081

(52) U.S. Cl. CPC C25B 11/036; C25B 1/23; C25B 11/081

(57) ABSTRACT

The present disclosure relates generally to electrochemical systems for syngas production, and more particularly to a bipolar membrane electrode assembly configured to produce syngas by coupling bicarbonate electrolysis at a cathode with aldehyde oxidation at an anode. An electrochemical system for producing syngas includes a cathode configured to receive a carbon dioxide-containing feedstock and to electrochemically reduce carbon dioxide to produce carbon monoxide. The system includes an anode configured to receive an organic compound and to electrochemically oxidize the organic compound to produce hydrogen gas. The system includes a bipolar membrane positioned between the cathode and the anode, the bipolar membrane configured to facilitate water dissociation and ion transport between the cathode and the anode. The carbon monoxide produced at the cathode and the hydrogen gas produced at the anode combine to form syngas.

### CROSS-REFERENCE TO RELATED APPLICATIONS

This application claims the benefit of U.S. Provisional Application Serial No. 63/791,029, filed on 18 Apr. 2025, which is incorporated herein by reference in its entirety as if fully set forth below.

### GOVERNMENT LICENSE RIGHTS

This invention was made with government support under DE-AR0001949 awarded by the U.S. Department of Energy. The government has certain rights in this invention.

### FIELD OF INVENTION

The present disclosure relates to electrochemical systems for syngas production, and more particularly to a bipolar membrane electrode assembly configured to produce syngas by coupling bicarbonate electrolysis at a cathode with aldehyde oxidation at an anode.

### BACKGROUND

Syngas, a mixture of hydrogen (H₂) and carbon monoxide (CO), is a foundational intermediate for fuels, chemicals, and emerging sustainable aviation fuel pathways. Syngas is traditionally produced by reforming or partial oxidation of fossil fuels such as natural gas, naphtha, and heavy oils. Alternative production methods include the gasification of coal, biomass, and municipal solid waste. The optimal H₂:CO ratio varies by application, with processes such as the Fischer-Tropsch method requiring syngas with a ratio between 1 and 2 to produce liquid fuels.

Fossil-based syngas production methods are energy-intensive and result in significant carbon dioxide (CO₂) emissions. Electrochemical syngas production offers a promising and environmentally friendly alternative. Recent advances in electrochemical CO₂ conversion have demonstrated that electrochemical CO production can be economically viable at scale. However, pure CO must be combined with H₂ to create usable syngas. To achieve the desired H₂:CO ratio, two primary electrochemical approaches are currently used.

FIG. 1A illustrates a first conventional approach utilizing a water electrolyzer 105 and a CO₂ electrolyzer 110 operating in a tandem configuration. The water electrolyzer 105 receives H₂O as input and produces O₂ and H₂ as outputs. The CO₂ electrolyzer 110 receives CO₂ and H₂O as inputs and produces CO and O₂ as outputs. The H₂ output from the water electrolyzer 105 and the CO output from the CO₂ electrolyzer 110 are combined to form syngas. While this method offers better control over the H₂:CO ratio, it requires higher capital investment and increased operational complexity due to the need for two separate electrolyzers.

FIG. 1B illustrates a second conventional approach where a single CO₂ electrolyzer generates both CO and H₂ simultaneously at the cathode by increasing the current density. In this configuration, both reactions compete for electrons at the cathode. Achieving the ideal H₂:CO ratio requires higher current densities, leading to significant kinetic limitations, higher overpotential, and reduced overall energy efficiency.

FIG. 2A illustrates a block diagram of a conventional electrocatalytic syngas production system that includes an air contactor 205, a CO₂ electrolyzer 210, a water electrolyzer 215, a syngas mixer 220, and a Fischer-Tropsch reactor 225. The air contactor 205 receives air as an input and produces a concentrated carbonate or bicarbonate solution containing captured CO₂. This concentrated solution, along with water, is fed to the CO₂ electrolyzer 210, which generates carbon monoxide at the cathode and oxygen at the anode. Separately, the water electrolyzer 215 receives water as an input and produces hydrogen at the cathode and oxygen at the anode. The carbon monoxide output from the CO₂ electrolyzer 210 and the hydrogen output from the water electrolyzer 215 are directed to the syngas mixer 220, where they are combined to form syngas. The syngas from the syngas mixer 220 is then fed to the Fischer-Tropsch reactor 225, which converts the syngas into hydrocarbons. This conventional configuration requires two separate electrolyzers operating in tandem to produce the desired syngas composition for downstream Fischer-Tropsch synthesis.

FIG. 2B illustrates a simplified conventional system where a single CO₂ electrolyzer produces both CO and H₂ at the cathode, with the combined output directed to a Fischer-Tropsch reactor. However, this approach suffers from the inherent trade-off between achieving high CO selectivity and producing syngas with application-relevant H₂:CO ratios.

Current CO₂ electrolyzer platforms are constrained by high energy consumption, limited syngas yield per unit charge, and poor integration between hydrogen and carbon monoxide production. In particular, the oxygen evolution reaction at the anode imposes a fundamental energetic penalty while contributing no value to the target product stream. The high thermodynamic potential and slow kinetics of the oxygen evolution reaction elevate the cell voltage. Such high-voltage operation increases energy costs and accelerates material degradation, compromising practical viability. Both conventional configurations are theoretically limited to a syngas molar yield per coulomb of 0.00517 mmol C⁻¹, as the anodic oxygen evolution reaction does not contribute to syngas formation.

What is needed, therefore, is an improved electrochemical syngas production system that addresses the limitations of conventional approaches. Such a system would reduce energy consumption, increase syngas yield per unit charge, and enable production of syngas with tunable H₂:CO ratios suitable for downstream applications such as Fischer-Tropsch synthesis within a single reactor configuration.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

An electrochemical system for producing syngas can include a cathode configured to receive a carbon dioxide-containing feedstock and to electrochemically reduce carbon dioxide to produce carbon monoxide. The system can include an anode configured to receive an organic compound and to electrochemically oxidize the organic compound to produce hydrogen gas. The system can include a bipolar membrane positioned between the cathode and the anode. The bipolar membrane can be configured to facilitate water dissociation and ion transport between the cathode and the anode. The carbon monoxide produced at the cathode and the hydrogen gas produced at the anode can combine to form syngas.

A membrane electrode assembly for electrolytic syngas production can include a cathode including a catalyst configured to reduce bicarbonate to carbon monoxide. The membrane electrode assembly can include an anode including a copper-based catalyst configured to oxidize an aldehyde to produce hydrogen gas and formate. The membrane electrode assembly can include a bipolar membrane disposed between the cathode and the anode. The bipolar membrane can be configured to generate protons at a cathode-facing side and hydroxide ions at an anode-facing side. The membrane electrode assembly can be configured to produce syngas including the carbon monoxide from the cathode and the hydrogen gas from the anode.

A method for electrolytically producing syngas can include supplying a bicarbonate solution to a cathode of an electrochemical cell. The method can include supplying an aldehyde solution to an anode of the electrochemical cell. The method can include applying a current to the electrochemical cell to electrochemically reduce bicarbonate at the cathode to produce carbon monoxide and to electrochemically oxidize the aldehyde at the anode to produce hydrogen gas. The method can include combining the carbon monoxide and the hydrogen gas to form syngas.

The foregoing general description of the illustrative embodiments and the following detailed description thereof are merely exemplary aspects of the teachings of this disclosure and are not restrictive.

### BRIEF DESCRIPTION OF THE DRAWINGS

Non-limiting and non-exhaustive examples are described with reference to the following figures.

FIG. 1A illustrates a block diagram of a conventional tandem electrolyzer system for syngas production.

FIG. 1B illustrates a block diagram of a conventional electrolyzer for syngas production.

FIG. 2A illustrates a block diagram of a conventional electrocatalytic syngas production system.

FIG. 2B illustrates a block diagram of a simplified conventional syngas production system.

FIG. 3 illustrates a schematic diagram of a full-cell electrolyzer configuration for syngas production, according to examples of the disclosed technology.

FIG. 4 illustrates a system diagram of an integrated electrochemical syngas production and conversion system, according to examples of the disclosed technology.

FIG. 5 illustrates a system diagram of a full-cell electrolyzer configuration for syngas production, according to examples of the disclosed technology.

FIG. 6 illustrates an exploded isometric view of a membrane electrode assembly for electrolytic syngas production, according to examples of the disclosed technology.

FIG. 7 illustrates a bar graph showing Faradaic efficiency and hydrogen-to-carbon monoxide ratios at various current densities, according to examples of the disclosed technology.

FIG. 8 illustrates a graph showing the relationship between current density, voltage difference, and cell voltage, according to examples of the disclosed technology.

FIG. 9 illustrates a graph comparing Faradaic efficiency and hydrogen-to-carbon monoxide ratio as a function of current density for two electrolyzer configurations, according to examples of the disclosed technology.

FIG. 10 illustrates a graph showing total syngas production rate as a function of current density for different electrolyzer configurations, according to examples of the disclosed technology.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to electrochemical systems and methods for syngas production. Syngas, a mixture of hydrogen (H₂) and carbon monoxide (CO), serves as a foundational intermediate for fuels, chemicals, and sustainable aviation fuel pathways. The disclosed technology provides a bipolar membrane electrode assembly configured to produce syngas by coupling bicarbonate electrolysis at a cathode with aldehyde oxidation at an anode.

Conventional electrochemical syngas production systems generate CO at the cathode while performing an oxygen evolution reaction at the anode. The oxygen evolution reaction imposes an energetic penalty while contributing no value to the target product stream. The disclosed technology addresses this limitation by replacing the oxygen evolution reaction with an aldehyde oxidation reaction that generates hydrogen gas at the anode. This configuration enables both electrodes to contribute to syngas component generation, with the cathode producing CO through carbon dioxide reduction and the anode producing H₂ through oxidation of organic compounds such as aldehydes.

The disclosed electrochemical system can achieve doubled syngas throughput compared to conventional CO₂ electrolysis approaches. Conventional configurations are theoretically limited to a syngas molar yield per coulomb of 0.00517 mmol C⁻¹, as the anodic oxygen evolution reaction does not contribute to syngas formation. The disclosed technology can achieve a theoretical molar yield per coulomb of 0.01034 mmol C⁻¹ by generating syngas components at both electrodes.

The disclosed system can operate at industrially relevant current densities while maintaining low cell voltages. In some configurations, the system can achieve a full-cell voltage of approximately 1.7 V while operating at a current density of 200 mA cm⁻². The system can maintain a combined Faradaic efficiency of approximately 200% for syngas production, with near-unity Faradaic efficiency for CO generation at the cathode and H₂ generation at the anode.

In some configurations, the disclosed system can maintain stable operation over extended periods. During stability testing at a current density of 200 mA cm⁻², the system can maintain near-unity Faradaic efficiency for both CO generation at the cathode and H₂ generation at the anode over 8 hours of continuous operation. The anolyte solution containing formaldehyde can be refreshed at regular intervals, such as every 30 minutes, during extended operation. No discernible changes in voltage or product distribution may be observed after refreshing the electrolyte. To maintain stable catholyte conditions, carbon dioxide can be continuously bubbled into the catholyte solution at a flow rate of approximately 400 sccm. The continuous CO₂ bubbling can convert hydroxide ions generated during electrolysis back into bicarbonate ions, thereby maintaining the bicarbonate concentration and enabling pseudo-steady-state operation throughout the stability testing period.

The disclosed technology can produce syngas with a hydrogen-to-carbon monoxide ratio suitable for downstream applications such as Fischer-Tropsch synthesis. The H₂:CO ratio can be tuned by adjusting the applied current density, with values ranging from approximately 1.0 to 2.1 across current densities from 100 to 600 mA cm⁻². This ratio range aligns with the requirements for Fischer-Tropsch synthesis, which typically requires syngas with a ratio between 1 and 2 to produce liquid fuels.

The disclosed system can utilize bicarbonate solutions as a carbon dioxide-containing feedstock at the cathode. Operating a bipolar membrane in reverse-bias mode can induce a locally acidic environment at the cathode-membrane interface, converting bicarbonate to gaseous CO₂ near the catalyst surface. The in situ generated CO₂ can then be reduced to CO, enabling direct use of bicarbonate solutions that are commonly produced by carbon capture technologies.

At the anode, the disclosed system can utilize organic compounds such as formaldehyde as feedstock for hydrogen generation. The anode can include a copper-based catalyst having mixed valence states of metallic copper and cuprous oxide. The oxidation of formaldehyde at the anode can produce hydrogen gas and formate as products. The formate byproduct can be recovered and monetized, providing an additional value stream.

The disclosed technology can reduce levelized energy requirements for syngas production compared to conventional electrochemical approaches. In some configurations, the BCE-FOR electrolyzer can achieve a levelized energy requirement of approximately 3.2 MWh per ton of syngas. This levelized energy requirement can be approximately 45% lower than that of conventional gaseous CO₂ electrolysis with oxygen evolution reaction (CO₂E-OER) and approximately 61% lower than that of bicarbonate electrolysis with oxygen evolution reaction (BCE-OER). The lower thermodynamic potential of the aldehyde oxidation reaction compared to the oxygen evolution reaction can contribute to reduced cell voltage and improved energy efficiency. The system can directly interface with carbon capture-derived bicarbonate feeds and produce an industrially relevant H₂:CO ratio within a single reactor configuration.

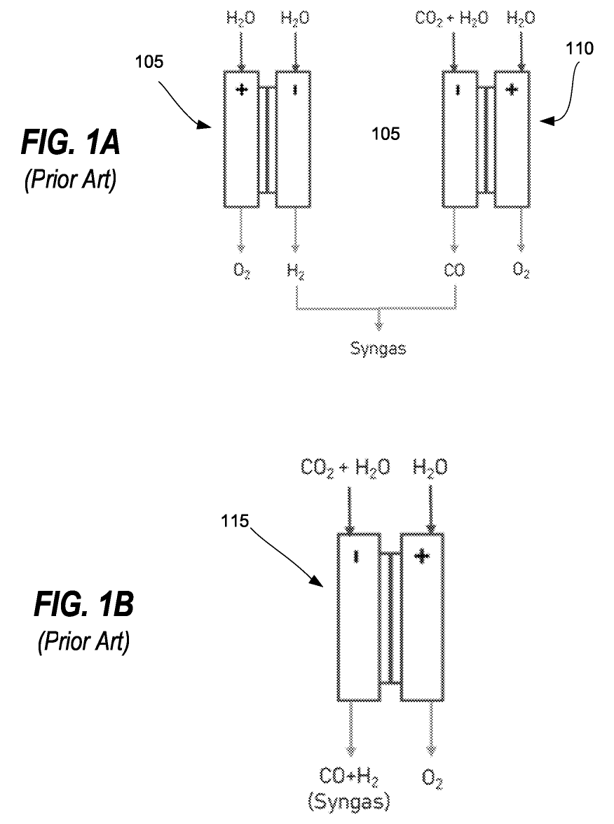

Referring now to FIGS. 1A and 1B, block diagrams comparing conventional electrochemical syngas production systems with a full-cell electrochemical syngas production system are illustrated. FIG. 1A depicts a conventional tandem configuration utilizing a water electrolyzer 105 and a CO₂ electrolyzer 110. The water electrolyzer 105 can receive H₂O as input and can produce O₂ and H₂ as outputs. The CO₂ electrolyzer 110 can receive CO₂ and H₂O as inputs and can produce CO and O₂ as outputs. The H₂ output from the water electrolyzer 105 and the CO output from the CO₂ electrolyzer 110 can be combined to form syngas. In the tandem configuration, two separate electrolyzers operate to achieve a desired syngas composition, with each electrolyzer having positive and negative electrodes as indicated.

A second conventional approach utilizes a single CO₂ electrolyzer where H₂ and CO are co-produced at the cathode using catalysts with moderate CO selectivity. In this configuration, both reactions compete for electrons at the cathode. Achieving an ideal H₂:CO ratio can require higher current densities, which can lead to kinetic limitations, higher overpotential, and reduced energy efficiency.

Both conventional configurations are theoretically limited to a syngas molar yield per coulomb of 0.00517 mmol C⁻¹, as the anodic oxygen evolution reaction does not contribute to syngas formation. The oxygen evolution reaction at the anode imposes an energetic penalty while contributing no value to the target product stream. The high thermodynamic potential and slow kinetics of the oxygen evolution reaction can elevate the cell voltage, which can increase energy costs and accelerate material degradation.

FIG. 1B illustrates a conventional electrolyzer 115 that integrates syngas production within a single reactor. The electrolyzer 115 can be referred to herein as an electrochemical system for producing syngas. The electrolyzer 115 can receive CO₂ and H₂O at one electrode and H₂O at another electrode. The electrolyzer 115 can produce CO and H₂ as a combined syngas output from one side and O₂ from the other side. The electrolyzer 115 includes positive and negative electrodes that enable simultaneous generation of both syngas components within a single electrochemical cell. This configuration can allow for direct production of syngas with a desired H₂:CO ratio without requiring separate electrolyzers or downstream mixing of gas streams. By enabling both electrodes to generate syngas components, the full-cell configuration can achieve a theoretical molar yield per coulomb of 0.01034 mmol C⁻¹, which is double that of conventional configurations.

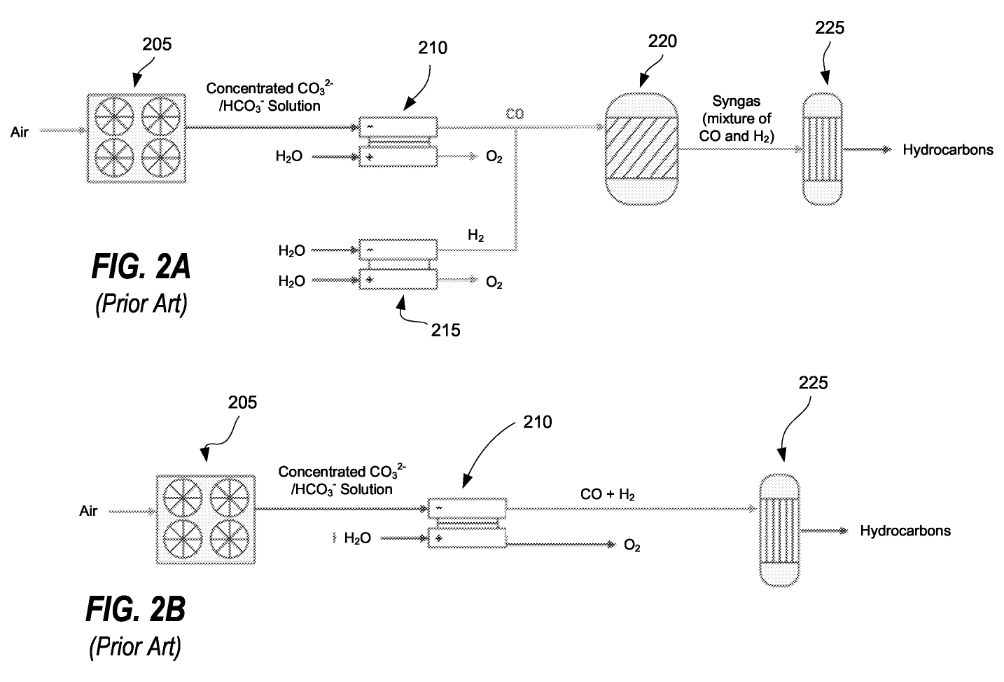

Referring now to FIGS. 2A and 2B, block diagrams of conventional electrocatalytic syngas production systems are illustrated. FIG. 2A depicts a conventional system that includes an air contactor 205, a CO₂ electrolyzer 210, a water electrolyzer 215, a syngas mixer 220, and a Fischer-Tropsch reactor 225.

The air contactor 205 can receive air as an input and can produce a concentrated carbonate or bicarbonate solution containing captured CO₂. The air contactor 205 can be referred to herein as a carbon capture unit or a direct air capture unit. The concentrated carbonate or bicarbonate solution from the air contactor 205 can be directed to the CO₂ electrolyzer 210.

The CO₂ electrolyzer 210 can receive the concentrated carbonate or bicarbonate solution from the air contactor 205 along with water. The CO₂ electrolyzer 210 can generate carbon monoxide at a cathode and oxygen at an anode. The CO₂ electrolyzer 210 can utilize a bipolar membrane to separate the cathode and anode compartments.

The water electrolyzer 215 can receive water as an input and can produce hydrogen at a cathode and oxygen at an anode. The water electrolyzer 215 operates separately from the CO₂ electrolyzer 210 to generate the hydrogen component of syngas.

The syngas mixer 220 can receive the carbon monoxide output from the CO₂ electrolyzer 210 and the hydrogen output from the water electrolyzer 215. The syngas mixer 220 can combine the carbon monoxide and hydrogen streams to form syngas having a desired H₂:CO ratio. The syngas mixer 220 can be referred to herein as a syngas makeup unit or a gas blending unit.

The Fischer-Tropsch reactor 225 can receive the syngas from the syngas mixer 220 and can convert the syngas into hydrocarbons. The Fischer-Tropsch reactor 225 can produce liquid fuels such as gasoline, diesel, and jet fuel from the syngas feedstock.

FIG. 2B illustrates a simplified conventional system where a single CO₂ electrolyzer produces both carbon monoxide and hydrogen at the cathode. In the configuration of FIG. 2B, the combined output from the cathode can be directed to a Fischer-Tropsch reactor without requiring a separate water electrolyzer or syngas mixer. However, the configuration of FIG. 2B can exhibit trade-offs between achieving high carbon monoxide selectivity and producing syngas with application-relevant H₂:CO ratios, as both reactions compete for electrons at the cathode.

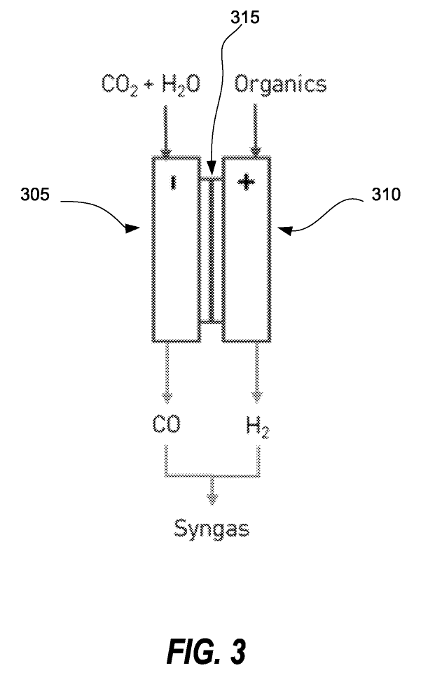

Referring now to FIG. 3, a schematic diagram of a full-cell electrolyzer configuration for syngas production is illustrated. The full-cell electrolyzer can be referred to herein as an electrochemical system for producing syngas. The full-cell electrolyzer includes a cathode 305, an anode 310, and a bipolar membrane 315 positioned between the cathode 305 and the anode 310.

The cathode 305 can be configured to receive a carbon dioxide-containing feedstock. In some configurations, the carbon dioxide-containing feedstock can include a bicarbonate solution. The bicarbonate solution can include potassium bicarbonate (KHCO₃). The cathode 305 can be configured to electrochemically reduce carbon dioxide to produce carbon monoxide. In some configurations, the cathode 305 can include a nickel single-atom catalyst (Ni-SAC) supported on carbon paper. In other configurations, the cathode 305 can include alternative catalysts such as copper or silver.

The anode 310 can be configured to receive an organic compound. In some configurations, the organic compound can include an aldehyde such as formaldehyde. The anode 310 can be configured to electrochemically oxidize the organic compound to produce hydrogen gas. The anode 310 can include a copper-based catalyst having mixed valence states of metallic copper and cuprous oxide (Cu/Cu₂O). In some configurations, the copper-based catalyst can be prepared by a synthesis procedure that includes cleaning commercial copper foam with ethanol and deionized water, followed by immersion in hydrochloric acid solution to remove native oxide layers from the surface. The cleaned copper foam can be immersed in an aqueous solution containing sodium hydroxide and ammonium persulfate at room temperature for approximately 30 minutes to induce growth of copper hydroxide (Cu(OH)₂) nanorods on the surface. The copper hydroxide-coated copper foam can be washed with deionized water and ethanol, dried under nitrogen flow, and calcined at approximately 550°C for approximately 3 hours under argon atmosphere to form cuprous oxide (Cu₂O)-coated copper foam. The cuprous oxide-coated copper foam can be subjected to electrochemical reduction at approximately -1.4 V versus a mercury/mercury oxide (Hg/HgO) reference electrode for approximately 400 seconds in potassium hydroxide solution to partially convert cuprous oxide into metallic copper, thereby forming the mixed-phase Cu/Cu₂O structure. The oxidation of formaldehyde at the anode 310 can produce hydrogen gas and formate as products. The formate byproduct can be recovered and monetized, providing an additional value stream.

The bipolar membrane 315 can separate the cathode 305 from the anode 310 while facilitating ion transport between the two electrode compartments. The bipolar membrane 315 can be configured to generate protons (H⁺) at a cathode-facing side and hydroxide ions (OH⁻) at an anode-facing side. In some configurations, the bipolar membrane 315 can be operated in reverse-bias mode. Under reverse-bias operation, water dissociation at the junction of the bipolar membrane 315 can generate protons that migrate toward the cathode 305 and hydroxide ions that migrate toward the anode 310.

At the cathode 305, the protons generated by the bipolar membrane 315 can create a locally acidic environment at the cathode-membrane interface. The locally acidic environment can convert bicarbonate ions to gaseous carbon dioxide near the catalyst surface. The in situ generated carbon dioxide can then be electrochemically reduced to carbon monoxide. This configuration can enable direct use of bicarbonate solutions that are commonly produced by carbon capture technologies such as direct air capture and flue gas absorption.

At the anode 310, the hydroxide ions generated by the bipolar membrane 315 can facilitate the oxidation of the aldehyde. The anodic hydrogen production can involve carbon-hydrogen bond cleavage of the aldehyde group, followed by surface hydrogen recombination. The aldehyde oxidation reaction can offer a thermodynamic potential approximately 1.45 V lower than that of the oxygen evolution reaction.

The carbon monoxide produced at the cathode 305 and the hydrogen gas produced at the anode 310 can be combined downstream to form syngas. This configuration can enable both electrodes to contribute to syngas component generation. By generating syngas components at both electrodes, the full-cell electrolyzer can achieve a theoretical molar yield per coulomb of 0.01034 mmol C⁻¹, which is double that of conventional configurations where the anodic oxygen evolution reaction does not contribute to syngas formation.

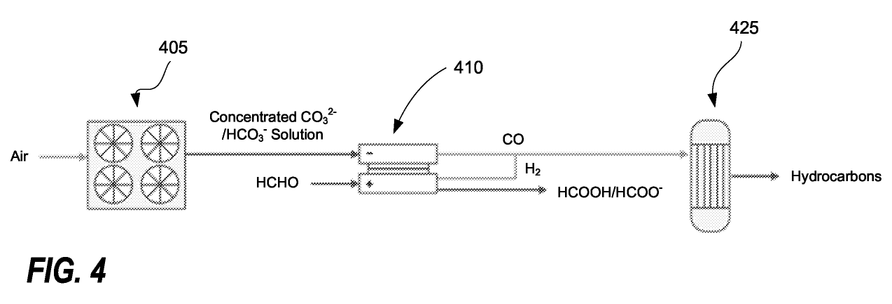

Referring now to FIG. 4, a system diagram of an integrated electrochemical syngas production and conversion system is illustrated. The integrated system includes an air contactor 405, a CO₂ electrolyzer 410, and a Fischer-Tropsch reactor 425. The CO₂ electrolyzer 410 can be referred to herein as a full-cell electrolyzer or an electrochemical system for producing syngas.

The air contactor 405 can receive air as an input and can produce a concentrated carbonate or bicarbonate solution containing captured CO₂. The air contactor 405 can be referred to herein as a carbon capture unit or a direct air capture unit. In some configurations, the air contactor 405 can capture CO₂ from concentrated sources such as flue gas. In other configurations, the air contactor 405 can capture CO₂ directly from ambient air. The concentrated carbonate or bicarbonate solution from the air contactor 405 can be directed to the CO₂ electrolyzer 410.

The CO₂ electrolyzer 410 can receive the concentrated carbonate or bicarbonate solution (CO₃ ²⁻/HCO₃ ⁻) from the air contactor 405 at a cathode side. The CO₂ electrolyzer 410 can also receive formaldehyde (HCHO) at an anode side. The CO₂ electrolyzer 410 can include a bipolar membrane separating the cathode side from the anode side. The bipolar membrane can be operated in reverse-bias mode to induce a locally acidic environment at a cathode-membrane interface, converting bicarbonate to gaseous CO₂ near a catalyst surface. The in situ generated CO₂ can then be reduced to carbon monoxide (CO) at the cathode.

At the anode side of the CO₂ electrolyzer 410, formaldehyde can be electrochemically oxidized to produce hydrogen gas (H₂). The oxidation of formaldehyde at the anode can also produce formic acid (HCOOH) or formate ions (HCOO⁻) as a byproduct. The formate byproduct can be recovered and monetized, providing an additional value stream. In some configurations, the formate can be recovered as formic acid through bipolar membrane electrodialysis (BPMED).

The CO₂ electrolyzer 410 can generate CO and H₂ outputs that can be directed to the Fischer-Tropsch reactor 425. The CO and H₂ outputs from the CO₂ electrolyzer 410 can combine to form syngas having a hydrogen-to-carbon monoxide ratio suitable for Fischer-Tropsch synthesis. The Fischer-Tropsch reactor 425 can convert the syngas into hydrocarbons as a final output. The hydrocarbons can include liquid fuels such as gasoline, diesel, and jet fuel.

The integrated system of FIG. 4 can enable direct conversion of captured CO₂ in the form of carbonate or bicarbonate solutions into syngas components without requiring intermediate CO₂ desorption or storage steps. The integrated system can eliminate the need for a separate water electrolyzer by generating hydrogen at the anode through formaldehyde oxidation rather than through water electrolysis. The integrated system can also eliminate the need for a syngas mixer by producing syngas with a desired H₂:CO ratio directly within the CO₂ electrolyzer 410.

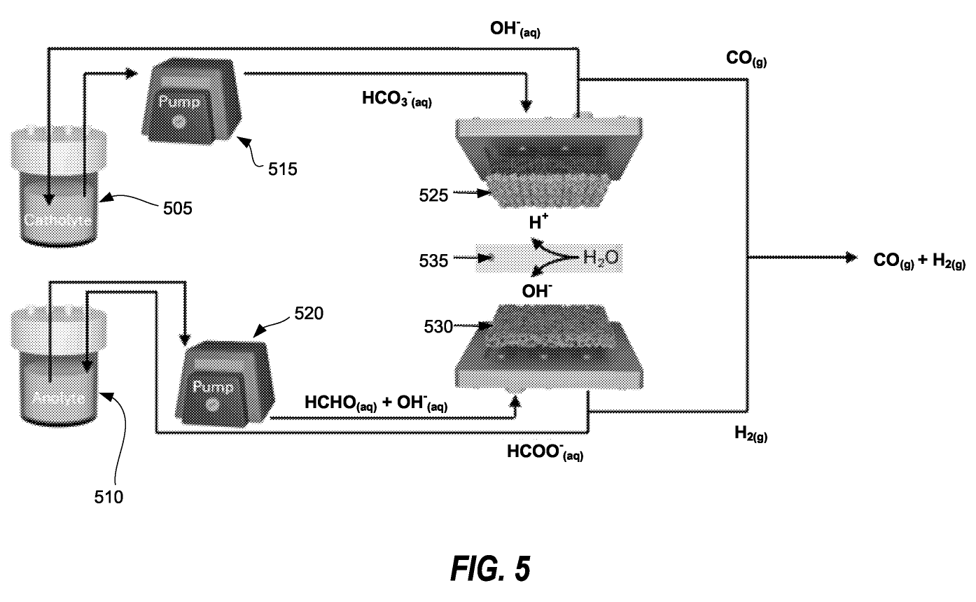

Referring now to FIG. 5, a system diagram of a full-cell electrolyzer configuration for syngas production is illustrated. The full-cell electrolyzer can be referred to herein as an electrochemical system for producing syngas. The system 500 includes a catholyte reservoir 505, an anolyte reservoir 510, a catholyte pump 515, an anolyte pump 520, a cathode 525, an anode 530, and a bipolar membrane 535.

The catholyte reservoir 505 can be configured to store a catholyte solution comprising bicarbonate ions (HCO₃ ⁻(aq)). In some configurations, the catholyte solution can include potassium bicarbonate (KHCO₃) at a concentration of approximately 3 M. The catholyte reservoir 505 can be fluidly connected to the cathode 525 through the catholyte pump 515.

The catholyte pump 515 can be configured to circulate the catholyte solution from the catholyte reservoir 505 to the cathode 525. In some configurations, the catholyte pump 515 can circulate the catholyte solution at a flow rate of approximately 30 mL min⁻¹. The catholyte pump 515 can include a peristaltic pump. The catholyte solution can be circulated through an interdigitated flow plate adjacent to the cathode 525.

The anolyte reservoir 510 can be configured to store an anolyte solution comprising formaldehyde (HCHO) and hydroxide ions (OH⁻(aq)). In some configurations, the anolyte solution can include formaldehyde at a concentration of approximately 1 M to 2 M and potassium hydroxide (KOH) at a concentration of approximately 1 M to 2 M. The anolyte reservoir 510 can be fluidly connected to the anode 530 through the anolyte pump 520.

The anolyte pump 520 can be configured to circulate the anolyte solution from the anolyte reservoir 510 to the anode 530. In some configurations, the anolyte pump 520 can circulate the anolyte solution at a flow rate of approximately 30 mL min⁻¹. The anolyte pump 520 can include a peristaltic pump.

The cathode 525 can be configured to receive the catholyte solution from the catholyte reservoir 505 and to electrochemically reduce carbon dioxide to produce carbon monoxide gas (CO(g)). The cathode 525 can include a nickel single-atom catalyst (Ni-SAC) supported on carbon paper. At the cathode 525, bicarbonate ions can be converted to gaseous carbon dioxide near the catalyst surface through a locally acidic environment induced by the bipolar membrane 535. The in situ generated carbon dioxide can then be electrochemically reduced to carbon monoxide. Hydroxide ions (OH⁻(aq)) generated as a byproduct of the carbon dioxide reduction reaction can be returned to the catholyte reservoir 505.

The anode 530 can be configured to receive the anolyte solution from the anolyte reservoir 510 and to electrochemically oxidize formaldehyde to produce hydrogen gas (H₂(g)). The anode 530 can include a copper-based catalyst having mixed valence states of metallic copper and cuprous oxide (Cu/Cu₂O). The oxidation of formaldehyde at the anode 530 can produce hydrogen gas and formate ions (HCOO⁻(aq)) as products.

The bipolar membrane 535 can separate the cathode 525 from the anode 530 and can facilitate water dissociation to generate protons (H⁺) and hydroxide ions (OH⁻). The bipolar membrane 435 can be operated in reverse-bias mode. Under reverse-bias operation, water dissociation at the junction of the bipolar membrane 435 can generate protons that migrate toward the cathode 525 and hydroxide ions that migrate toward the anode 530. The protons generated by the bipolar membrane 435 can create a locally acidic environment at the cathode-membrane interface, facilitating the conversion of bicarbonate ions to gaseous carbon dioxide for subsequent electrochemical reduction.

The gaseous products from both the cathode 525 and the anode 530 can combine to form syngas (CO(g) + H₂(g)). The syngas can exit the system for downstream processing, such as Fischer-Tropsch synthesis.

In some configurations, the system 500 can include continuous carbon dioxide bubbling into the catholyte solution stored in the catholyte reservoir 505. During electrolysis, hydroxide ions can be generated as a byproduct of the carbon dioxide reduction reaction at the cathode 525. The generation of hydroxide ions can cause the bulk pH of the catholyte solution to increase over time. As the pH increases, the in situ generation of carbon dioxide from bicarbonate can be hindered, which can lead to a decline in carbon dioxide reduction activity. To mitigate this issue, carbon dioxide can be continuously bubbled into the catholyte solution in the catholyte reservoir 505. The continuous supply of carbon dioxide can convert hydroxide ions back into bicarbonate ions, thereby maintaining the bicarbonate concentration in the catholyte solution. In some configurations, carbon dioxide can be bubbled into the catholyte solution at a flow rate of approximately 400 sccm using a mass flow controller. The continuous carbon dioxide bubbling can enable the system 500 to operate under pseudo-steady-state conditions during electrolysis, maintaining high Faradaic efficiency for carbon monoxide production and stable pH conditions over extended operation periods.

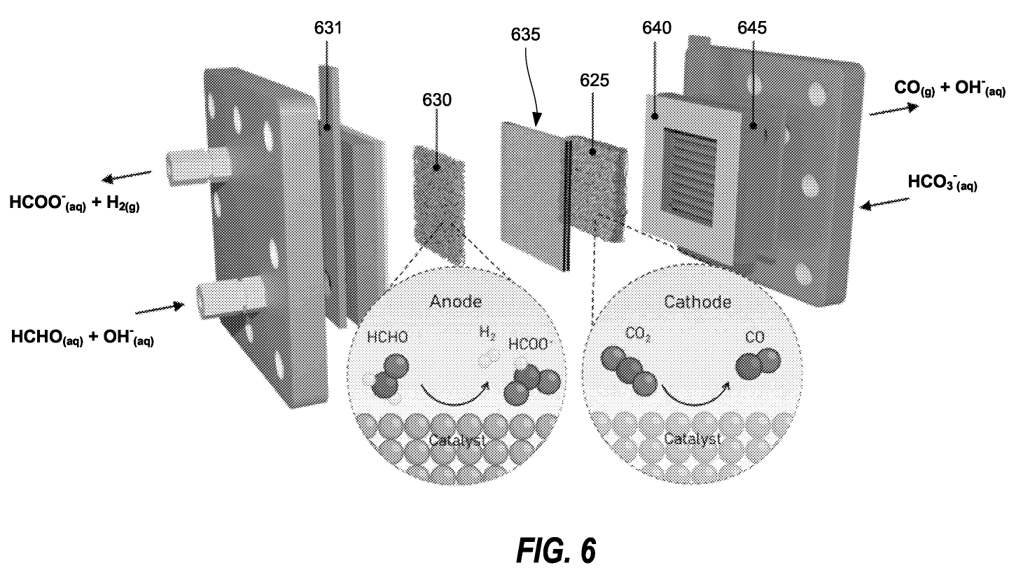

Referring now to FIG. 6, an exploded isometric view of a membrane electrode assembly for electrolytic syngas production is illustrated. The membrane electrode assembly can be referred to herein as an electrochemical system for producing syngas. The membrane electrode assembly includes a cathode 625, an anode 630, an anode current collector 631, a bipolar membrane 635, a gasket 640, and a cathode flow field plate 645.

The cathode 625 can be positioned adjacent to the bipolar membrane 635. The cathode 625 can include a catalyst configured to reduce bicarbonate to carbon monoxide. In some configurations, the cathode 625 can include a nickel single-atom catalyst (Ni-SAC) supported on carbon paper. The cathode 625 can receive a catholyte solution comprising bicarbonate ions (HCO₃ ⁻) from the cathode flow field plate 645. At the cathode 625, carbon dioxide (CO₂) can be electrochemically reduced to produce carbon monoxide (CO). The locally acidic environment at the cathode-membrane interface, induced by protons generated from the bipolar membrane 635, can convert bicarbonate ions to gaseous carbon dioxide near the catalyst surface for subsequent electrochemical reduction.

The anode 630 can be positioned on an opposite side of the bipolar membrane 635 from the cathode 625. The anode 630 can include a copper-based catalyst configured to oxidize an aldehyde to produce hydrogen gas and formate. In some configurations, the anode 630 can include a mixed valence copper electrode having both metallic copper and cuprous oxide (Cu/Cu₂O). The anode 630 can receive an anolyte solution comprising formaldehyde (HCHO) and hydroxide ions (OH⁻). At the anode 630, formaldehyde can be electrochemically oxidized to produce hydrogen gas (H₂) and formate ions (HCOO⁻). The oxidation of formaldehyde at the anode 630 can involve carbon-hydrogen bond cleavage of the aldehyde group, followed by surface hydrogen recombination.

The anode current collector 631 can be positioned adjacent to the anode 630. The anode current collector 631 can include inlet and outlet ports for fluid flow. The anode current collector 631 can facilitate electrical connection to the anode 630 and can enable circulation of the anolyte solution through the anode compartment.

The bipolar membrane 635 can be disposed between the cathode 625 and the anode 630. The bipolar membrane 635 can be configured to generate protons (H⁺) at a cathode-facing side and hydroxide ions (OH⁻) at an anode-facing side. In some configurations, the bipolar membrane 635 can be operated in reverse-bias mode. Under reverse-bias operation, water dissociation at the junction of the bipolar membrane 635 can generate protons that migrate toward the cathode 625 and hydroxide ions that migrate toward the anode 630. The bipolar membrane 635 can include a cation-exchange membrane layered with an anion-exchange membrane. In some configurations, the bipolar membrane 635 can include a catalyst interlayer at the junction to assist water dissociation. In some configurations, the bipolar membrane 635 can include a synthetic bipolar membrane. The synthetic bipolar membrane can include an anion-exchange membrane comprising PAP-TP-85. The synthetic bipolar membrane can include a cation-exchange membrane comprising sulfonated poly(ether ether ketone) (SPEEK). The synthetic bipolar membrane can include a tin oxide (SnO₂) catalyst interlayer positioned at the junction between the anion-exchange membrane and the cation-exchange membrane to assist water dissociation. The synthetic bipolar membrane can enable operation at a full-cell voltage of approximately 1.7 V at a current density of 200 mA cm⁻². The catalyst interlayer and highly conductive polymer layers can facilitate water dissociation and enhance ionic transport.

The gasket 640 can be positioned between the bipolar membrane 635 and the cathode flow field plate 645. The gasket 640 can provide a seal between the cathode compartment and the anode compartment. In some configurations, the gasket 640 can include a polytetrafluoroethylene (PTFE) material.

The cathode flow field plate 645 can include a flow field pattern and inlet and outlet ports. The cathode flow field plate 645 can be configured to distribute the catholyte solution across the cathode 625. In some configurations, the cathode flow field plate 645 can include an interdigitated flow field pattern. The cathode flow field plate 645 can include a graphite material.

The membrane electrode assembly can be configured to produce syngas comprising the carbon monoxide from the cathode 625 and the hydrogen gas from the anode 630. The carbon monoxide produced at the cathode 625 and the hydrogen gas produced at the anode 630 can be combined downstream to form syngas. The membrane electrode assembly can enable both electrodes to contribute to syngas component generation, with the cathode 625 producing carbon monoxide through carbon dioxide reduction and the anode 630 producing hydrogen through oxidation of formaldehyde.

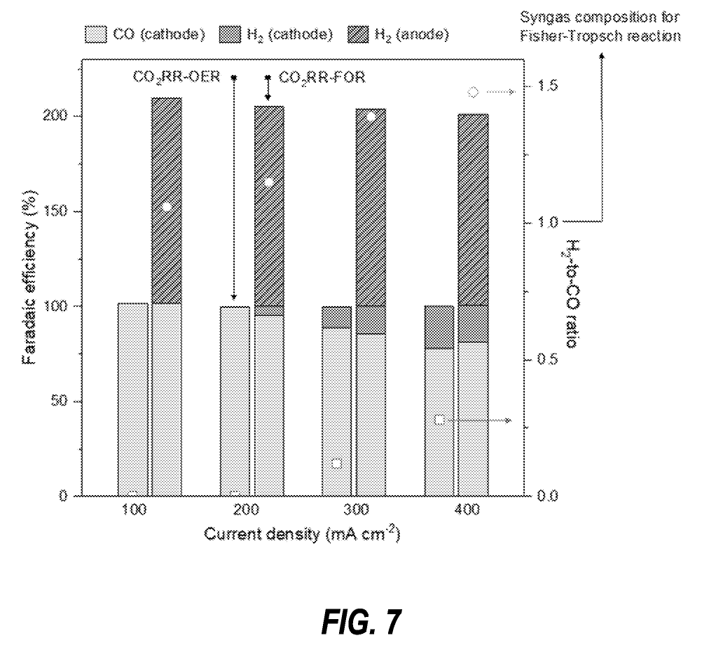

Referring now to FIG. 7, a bar graph showing Faradaic efficiency percentages and hydrogen-to-carbon monoxide ratios at various current densities for a syngas production system is illustrated. FIG. 7 can be referred to herein as a performance characterization of the full-cell electrolyzer or the electrochemical system for producing syngas.

FIG. 7 depicts the horizontal axis representing current density in milliamperes per square centimeter, with values at 100, 200, 300, and 400 mA cm⁻². The left vertical axis represents Faradaic efficiency as a percentage, ranging from 0 to above 200 percent. The right vertical axis represents the hydrogen-to-carbon monoxide ratio, ranging from 0.0 to 1.5.

Each current density value in FIG. 7 displays a stacked bar comprising three components: carbon monoxide produced at the cathode, hydrogen produced at the cathode, and hydrogen produced at the anode. The graph indicates two system configurations: a bicarbonate electrolysis configuration with oxygen evolution reaction (BCE-OER) and a bicarbonate electrolysis configuration with formaldehyde oxidation reaction (BCE-FOR).

In the BCE-FOR configuration, the cathode can produce carbon monoxide through electrochemical reduction of bicarbonate, while the anode can produce hydrogen through electrochemical oxidation of formaldehyde. The combined Faradaic efficiency from both electrodes can approach approximately 200 percent for syngas production. The combined Faradaic efficiency of approximately 200 percent reflects the contributions from both electrode compartments, with near-unity Faradaic efficiency for carbon monoxide generation at the cathode and near-unity Faradaic efficiency for hydrogen generation at the anode.

In contrast, the BCE-OER configuration can produce carbon monoxide at the cathode while performing an oxygen evolution reaction at the anode. The oxygen evolution reaction does not contribute to syngas formation, resulting in a lower combined Faradaic efficiency and an unfavorable hydrogen-to-carbon monoxide ratio.

A shaded region on the right side of FIG. 7 indicates the syngas composition range suitable for the Fischer-Tropsch reaction, corresponding to hydrogen-to-carbon monoxide ratios between approximately 1.0 and 2.0. The BCE-FOR configuration can achieve hydrogen-to-carbon monoxide ratios within the Fischer-Tropsch process range across the tested current densities. At current densities of 100, 200, and 300 mA cm⁻², the BCE-FOR configuration can achieve hydrogen-to-carbon monoxide ratios between approximately 1.0 and 1.23.

The hydrogen-to-carbon monoxide ratio can be tuned by adjusting the applied current density. At lower current densities, the cathode can produce predominantly carbon monoxide with minimal hydrogen, while the anode can generate hydrogen through the formaldehyde oxidation reaction. As the current density increases, the relative contributions of hydrogen and carbon monoxide can shift, enabling adjustment of the syngas composition.

The BCE-FOR configuration can maintain high Faradaic efficiency for syngas production across a range of industrially relevant current densities. At a current density of 200 mA cm⁻², the system can maintain a combined Faradaic efficiency of approximately 200 percent while producing syngas with a hydrogen-to-carbon monoxide ratio of approximately 1.0. The system can operate stably at this current density with a full-cell voltage of approximately 1.7 V when using a synthetic bipolar membrane.

The BCE-OER configuration can produce hydrogen-to-carbon monoxide ratios below 1.0 across the tested current densities, as the oxygen evolution reaction at the anode does not contribute hydrogen to the syngas product stream. At a current density of 100 mA cm⁻², the BCE-OER configuration can produce a hydrogen-to-carbon monoxide ratio of approximately 0.03, with the cathode producing predominantly carbon monoxide. As the current density increases in the BCE-OER configuration, the hydrogen-to-carbon monoxide ratio can increase due to increased hydrogen evolution at the cathode, but the ratio can remain below the optimal range for Fischer-Tropsch synthesis.

The performance data illustrated in FIG. 7 demonstrates that the BCE-FOR configuration can enable production of syngas with hydrogen-to-carbon monoxide ratios suitable for downstream Fischer-Tropsch synthesis within a single reactor configuration. The BCE-FOR configuration can achieve doubled syngas throughput compared to the BCE-OER configuration at equivalent current densities, as both electrodes contribute to syngas component generation.

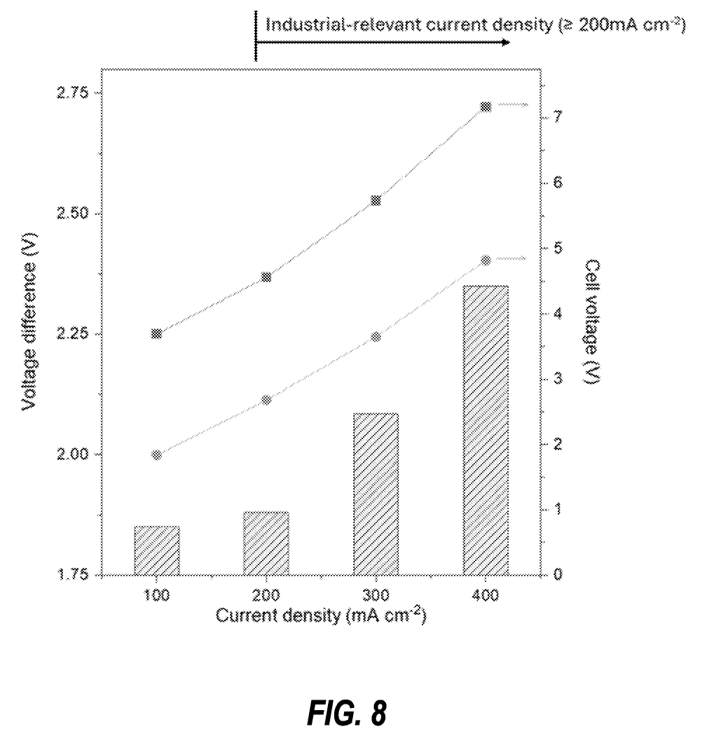

Referring now to FIG. 8, a graph showing the relationship between current density, voltage difference, and cell voltage for the full-cell electrolyzer is illustrated. FIG. 8 can be referred to herein as a voltage characterization of the electrochemical system for producing syngas. The horizontal axis of FIG. 8 represents current density in mA cm⁻², ranging from 100 to 400 mA cm⁻². The left vertical axis represents voltage difference in volts, while the right vertical axis represents cell voltage in volts.

FIG. 8 depicts a series of hatched bars indicating the voltage difference between the bicarbonate electrolysis configuration with formaldehyde oxidation reaction (BCE-FOR) and the bicarbonate electrolysis configuration with oxygen evolution reaction (BCE-OER) at each current density level. The voltage difference can increase as the current density increases from 100 to 400 mA cm⁻². The voltage difference can be attributed to the thermodynamic potential difference between the oxygen evolution reaction and the formaldehyde oxidation reaction, which is theoretically approximately 1.45 V.

Two line plots with data point markers are superimposed on the bar chart in FIG. 8. A first line plot with circular markers shows cell voltage values for the BCE-FOR configuration. A second line plot with square markers shows cell voltage values for the BCE-OER configuration. The BCE-OER configuration can exhibit higher cell voltage values compared to the BCE-FOR configuration across all tested current densities.

At industrially relevant current densities of 200 mA cm⁻² or greater, the BCE-FOR configuration can exhibit a notable voltage reduction compared to the BCE-OER configuration. When using a commercial bipolar membrane (c-BPM), the BCE-FOR configuration can exhibit a voltage reduction of approximately 1.6 V compared to the BCE-OER configuration at a current density of 200 mA cm⁻². The voltage reduction can be primarily attributed to the thermodynamic potential difference between the oxygen evolution reaction and the formaldehyde oxidation reaction.

The cell voltage can be further reduced by introducing a synthetic bipolar membrane (s-BPM). The BCE-FOR configuration with the synthetic bipolar membrane can exhibit stable operation at a full-cell voltage of approximately 1.7 V at a current density of 200 mA cm⁻². The reduction in cell voltage can be attributed to a catalyst layer design at the bipolar membrane junction and the use of highly conductive polymer layers, which together can facilitate water dissociation and enhance ionic transport.

The full-cell electrolyzer operating at a cell voltage of approximately 1.7 V can be comparable to state-of-the-art water electrolyzers, which typically operate at cell voltages of less than 2 V. The low cell voltage operation can enable compatibility with existing water electrolysis infrastructure. The low cell voltage can reduce concerns about high-voltage-induced side reactions or adverse effects on electrode materials.

At a current density of 100 mA cm⁻², the BCE-FOR configuration can operate at a voltage of approximately 1.74 V. At a current density of 200 mA cm⁻², the BCE-FOR configuration can operate at a voltage of approximately 2.52 V when using a commercial bipolar membrane. At a current density of 300 mA cm⁻², the BCE-FOR configuration can operate at a voltage of approximately 3.51 V. In contrast, the BCE-OER configuration can operate at voltages of approximately 3.54 V, 4.12 V, and 4.79 V at current densities of 100, 200, and 300 mA cm⁻², respectively.

The BCE-FOR configuration can operate at approximately half the voltage of the conventional BCE-OER configuration at a current density of 100 mA cm⁻². The reduced cell voltage can improve energy efficiency and reduce operational costs. The lower thermodynamic potential of the aldehyde oxidation reaction compared to the oxygen evolution reaction can contribute to the reduced cell voltage across all tested current densities.

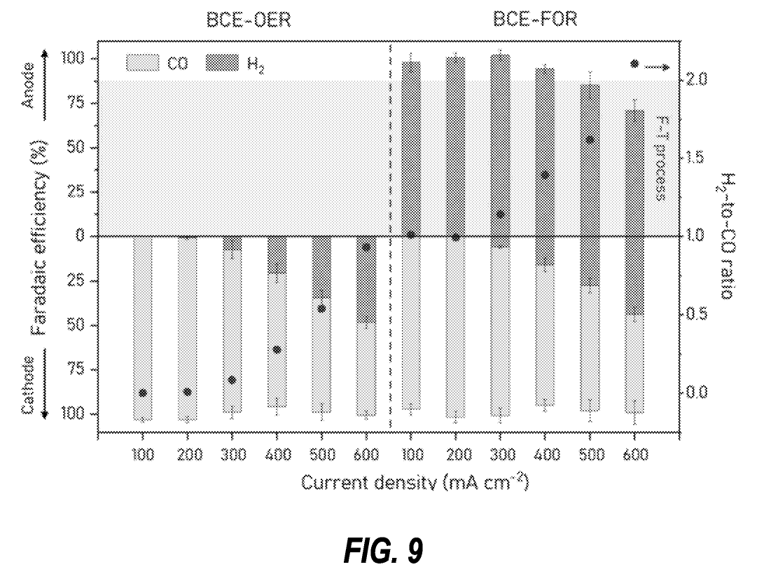

Referring now to FIG. 9, a graph comparing Faradaic efficiency and hydrogen-to-carbon monoxide ratio as a function of current density for two electrolyzer configurations is illustrated. FIG. 9 can be referred to herein as a performance comparison between the bicarbonate electrolysis configuration with oxygen evolution reaction (BCE-OER) and the bicarbonate electrolysis configuration with formaldehyde oxidation reaction (BCE-FOR).

The horizontal axis of FIG. 9 represents current density in milliamperes per square centimeter, ranging from 100 to 600 mA cm⁻². The left vertical axis represents Faradaic efficiency as a percentage. The right vertical axis represents the hydrogen-to-carbon monoxide ratio. A vertical dashed line divides the graph into two sections, with the BCE-OER configuration shown on one side and the BCE-FOR configuration shown on the other side.

FIG. 9 depicts bar charts displaying the Faradaic efficiency for carbon monoxide and hydrogen at both the cathode and the anode. Cathodic products can be shown as downward-extending bars, and anodic products can be shown as upward-extending bars. Dot markers indicate the resulting hydrogen-to-carbon monoxide ratio at each current density. A shaded horizontal band spanning the upper portion of the graph indicates the hydrogen-to-carbon monoxide ratio range suitable for the Fischer-Tropsch process, corresponding to ratio values between approximately 1.0 and 2.0.

In the BCE-OER configuration, the cathode can produce predominantly carbon monoxide with minimal hydrogen production at lower current densities. The oxygen evolution reaction at the anode does not contribute hydrogen to the syngas product stream. The BCE-OER configuration can produce hydrogen-to-carbon monoxide ratios ranging from approximately 0 to 0.9 across the tested current densities. At a current density of 100 mA cm⁻², the BCE-OER configuration can produce a hydrogen-to-carbon monoxide ratio of approximately 0.03, with the cathode producing predominantly carbon monoxide. As the current density increases in the BCE-OER configuration, the hydrogen-to-carbon monoxide ratio can increase due to increased hydrogen evolution at the cathode, but the ratio can remain below the range suitable for Fischer-Tropsch synthesis.

In the BCE-FOR configuration, the cathode can produce carbon monoxide through electrochemical reduction of bicarbonate, while the anode can produce hydrogen through electrochemical oxidation of formaldehyde. The BCE-FOR configuration can achieve hydrogen-to-carbon monoxide ratios within the Fischer-Tropsch process range across the tested current densities. At current densities from 100 to 600 mA cm⁻², the BCE-FOR configuration can achieve hydrogen-to-carbon monoxide ratios between approximately 1.0 and 2.1. The hydrogen-to-carbon monoxide ratio of 1.0 to 2.1 aligns with the requirements for Fischer-Tropsch synthesis, which typically requires syngas with a ratio between 1 and 2 to produce liquid fuels.

The BCE-FOR configuration can achieve a combined Faradaic efficiency approaching approximately 200 percent for syngas production. The combined Faradaic efficiency of approximately 200 percent reflects the contributions from both electrode compartments, with near-unity Faradaic efficiency for carbon monoxide generation at the cathode and near-unity Faradaic efficiency for hydrogen generation at the anode. In contrast, the BCE-OER configuration can achieve a lower combined Faradaic efficiency, as the oxygen evolution reaction at the anode does not contribute to syngas formation.

The formaldehyde oxidation reaction at the anode can offer a thermodynamic potential approximately 1.45 V lower than that of the oxygen evolution reaction. The lower thermodynamic potential of the formaldehyde oxidation reaction can contribute to reduced cell voltage and improved energy efficiency compared to the BCE-OER configuration. The BCE-FOR configuration can exhibit a voltage reduction of approximately 1.6 V compared to the BCE-OER configuration at a current density of 200 mA cm⁻² when using a commercial bipolar membrane.

The BCE-FOR configuration can enable both electrodes to contribute to syngas component generation. By generating syngas components at both electrodes, the BCE-FOR configuration can achieve a theoretical molar yield per coulomb of 0.01034 mmol C⁻¹, which is double that of the BCE-OER configuration where the anodic oxygen evolution reaction does not contribute to syngas formation. The BCE-FOR configuration can achieve comparable syngas throughput at 300 mA cm⁻² while requiring only half the current compared to the BCE-OER configuration operating at 600 mA cm⁻².

The performance data illustrated in FIG. 9 demonstrates that the BCE-FOR configuration can enable production of syngas with hydrogen-to-carbon monoxide ratios suitable for downstream Fischer-Tropsch synthesis within a single reactor configuration. The BCE-FOR configuration can address the inherent trade-off in conventional carbon dioxide electrolysis between achieving high carbon monoxide selectivity and producing syngas with application-relevant hydrogen-to-carbon monoxide ratios.

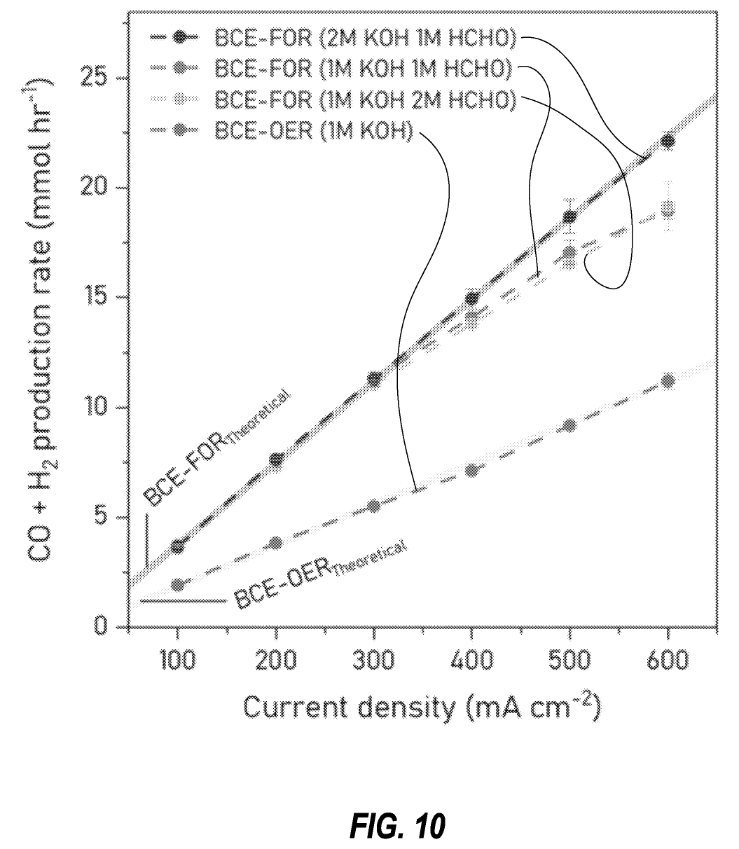

Referring now to FIG. 10, a graph showing total syngas production rate as a function of current density for different electrolyzer configurations is illustrated. FIG. 10 can be referred to herein as a production rate characterization of the full-cell electrolyzer or the electrochemical system for producing syngas. The horizontal axis of FIG. 10 represents current density in milliamperes per square centimeter, ranging from 100 to 600 mA cm⁻². The vertical axis represents the combined carbon monoxide and hydrogen production rate in millimoles per hour.

FIG. 10 depicts four data series corresponding to different electrolyte compositions and reaction configurations. Three data series represent BCE-FOR configurations with varying concentrations of potassium hydroxide and formaldehyde, while one data series represents a BCE-OER configuration with 1 M potassium hydroxide. Two theoretical trend lines are shown in FIG. 10, one labeled BCE-FOR Theoretical and one labeled BCE-OER Theoretical, both extending linearly from the origin.

The BCE-FOR configuration can achieve approximately double the syngas production rate compared to the BCE-OER configuration at equivalent current densities. The doubled syngas production rate can be attributed to both electrodes contributing to syngas component generation in the BCE-FOR configuration. In the BCE-FOR configuration, the cathode can produce carbon monoxide through electrochemical reduction of bicarbonate, while the anode can produce hydrogen through electrochemical oxidation of formaldehyde. In contrast, the BCE-OER configuration can produce carbon monoxide at the cathode while performing an oxygen evolution reaction at the anode, where the oxygen evolution reaction does not contribute to syngas formation.

The BCE-FOR configuration can achieve a theoretical molar yield per coulomb of 0.01034 mmol C⁻¹. Conventional configurations, including the BCE-OER configuration, can be limited to a theoretical molar yield per coulomb of 0.00517 mmol C⁻¹, as the anodic oxygen evolution reaction does not contribute to syngas formation. The theoretical molar yield per coulomb of the BCE-FOR configuration can be double that of conventional configurations.

The BCE-FOR data points with 2 M potassium hydroxide and 1 M formaldehyde can closely follow the BCE-FOR theoretical line across the entire current density range tested. The BCE-FOR data points with 1 M potassium hydroxide and 1 M formaldehyde, as well as those with 1 M potassium hydroxide and 2 M formaldehyde, can begin to deviate below the theoretical line at higher current densities, particularly above 400 mA cm⁻². The BCE-OER data points can follow the BCE-OER theoretical line, which exhibits a lower slope compared to the BCE-FOR theoretical line.

The total carbon monoxide and hydrogen production in the BCE-FOR system can begin to decline when the current density exceeds 400 mA cm⁻². At a current density of 600 mA cm⁻², the production rate can be approximately 85% of the theoretical value. The decrease in total syngas output at elevated current densities can be attributed to reduction in anodic performance, while the cathode can remain stable under these experimental conditions.

Increasing the potassium hydroxide concentration while maintaining the formaldehyde level can restore the total carbon monoxide and hydrogen production rate to values consistent with theoretical predictions. The BCE-FOR configuration with 2 M potassium hydroxide and 1 M formaldehyde can maintain syngas production rates consistent with theoretical values across the tested current density range, including at current densities of 400 mA cm⁻² and above.

The BCE-FOR configuration can achieve comparable syngas throughput at 300 mA cm⁻² while requiring only half the current compared to the BCE-OER configuration operating at 600 mA cm⁻². The doubled syngas throughput of the BCE-FOR configuration can enable reduced current requirements for achieving equivalent syngas production rates, which can contribute to improved energy efficiency and reduced operational costs.

The disclosed technology includes methods for electrolytically producing syngas. A method for electrolytically producing syngas can include supplying a bicarbonate solution to a cathode of an electrochemical cell, supplying an aldehyde solution to an anode of the electrochemical cell, applying a current to the electrochemical cell to electrochemically reduce bicarbonate at the cathode to produce carbon monoxide and to electrochemically oxidize the aldehyde at the anode to produce hydrogen gas, and combining the carbon monoxide and the hydrogen gas to form syngas.

The bicarbonate solution can be supplied to the cathode as a catholyte. In some configurations, the bicarbonate solution can include potassium bicarbonate (KHCO₃) at a concentration of approximately 3 M. The bicarbonate solution can be circulated from a catholyte reservoir to the cathode using a catholyte pump. In some configurations, the catholyte pump can circulate the bicarbonate solution at a flow rate of approximately 30 mL min⁻¹. The bicarbonate solution can be circulated through an interdigitated flow field plate adjacent to the cathode.

The aldehyde solution can be supplied to the anode as an anolyte. In some configurations, the aldehyde solution can include formaldehyde and potassium hydroxide. The formaldehyde concentration can be approximately 1 M to 2 M, and the potassium hydroxide concentration can be approximately 1 M to 2 M. The aldehyde solution can be circulated from an anolyte reservoir to the anode using an anolyte pump. In some configurations, the anolyte pump can circulate the aldehyde solution at a flow rate of approximately 30 mL min⁻¹.

The electrochemical cell can include a bipolar membrane separating the cathode and the anode. The bipolar membrane can be operated in reverse-bias mode to generate a locally acidic environment at a cathode-membrane interface. Under reverse-bias operation, water dissociation at the junction of the bipolar membrane can generate protons (H⁺) that migrate toward the cathode and hydroxide ions (OH⁻) that migrate toward the anode.

At the cathode, the protons generated by the bipolar membrane can create a locally acidic environment at the cathode-membrane interface. The locally acidic environment can convert bicarbonate ions to gaseous carbon dioxide near the catalyst surface. The in situ generated carbon dioxide can then be electrochemically reduced to carbon monoxide. This configuration can enable direct use of bicarbonate solutions that are commonly produced by carbon capture technologies such as direct air capture and flue gas absorption.

At the anode, the hydroxide ions generated by the bipolar membrane can facilitate the oxidation of the aldehyde. The oxidation of the aldehyde at the anode can produce hydrogen gas and formate as products. The formate byproduct can be recovered and monetized, providing an additional value stream. In some configurations, the formate can be recovered as formic acid through bipolar membrane electrodialysis.

Applying a current to the electrochemical cell can include applying a current density ranging from approximately 100 mA cm⁻² to approximately 600 mA cm⁻². In some configurations, the electrochemical cell can operate at a current density of at least 200 mA cm⁻². The current density can be adjusted to tune the hydrogen-to-carbon monoxide ratio of the syngas product.

The method can include continuously bubbling carbon dioxide into the bicarbonate solution stored in the catholyte reservoir. During electrolysis, hydroxide ions can be generated as a byproduct of the carbon dioxide reduction reaction at the cathode. The generation of hydroxide ions can cause the bulk pH of the catholyte solution to increase over time. As the pH increases, the in situ generation of carbon dioxide from bicarbonate can be hindered, which can lead to a decline in carbon dioxide reduction activity. To mitigate this issue, carbon dioxide can be continuously bubbled into the catholyte solution. The continuous supply of carbon dioxide can convert hydroxide ions back into bicarbonate ions, thereby maintaining the bicarbonate concentration in the catholyte solution. In some configurations, carbon dioxide can be bubbled into the catholyte solution at a flow rate of approximately 400 sccm. The continuous carbon dioxide bubbling can enable the electrochemical cell to operate under pseudo-steady-state conditions during electrolysis, maintaining high Faradaic efficiency for carbon monoxide production and stable pH conditions over extended operation periods.

The syngas produced by the method can have a hydrogen-to-carbon monoxide ratio between 1 and 2. The hydrogen-to-carbon monoxide ratio can be tuned by adjusting the applied current density. At lower current densities, the cathode can produce predominantly carbon monoxide with minimal hydrogen, while the anode can generate hydrogen through the aldehyde oxidation reaction. As the current density increases, the relative contributions of hydrogen and carbon monoxide can shift, enabling adjustment of the syngas composition.

The method can further include directing the syngas to a Fischer-Tropsch reactor for conversion to hydrocarbons. The Fischer-Tropsch reactor can convert the syngas into liquid fuels such as gasoline, diesel, and jet fuel. The hydrogen-to-carbon monoxide ratio of 1 to 2 produced by the method can align with the requirements for Fischer-Tropsch synthesis.

The method can achieve a combined Faradaic efficiency of approximately 200% for syngas production. The combined Faradaic efficiency of approximately 200% can reflect the contributions from both electrode compartments, with near-unity Faradaic efficiency for carbon monoxide generation at the cathode and near-unity Faradaic efficiency for hydrogen generation at the anode.

The method can achieve doubled syngas throughput compared to conventional carbon dioxide electrolysis approaches. Conventional configurations can be limited to a theoretical molar yield per coulomb of 0.00517 mmol C⁻¹, as the anodic oxygen evolution reaction does not contribute to syngas formation. The method can achieve a theoretical molar yield per coulomb of 0.01034 mmol C⁻¹ by generating syngas components at both electrodes.

The disclosed technology can be further understood according to the following clauses:

Clause 1: An electrochemical system for producing syngas, the system comprising:
a cathode configured to receive a carbon dioxide-containing feedstock and to electrochemically reduce carbon dioxide to produce carbon monoxide;
an anode configured to receive an organic compound and to electrochemically oxidize the organic compound to produce hydrogen gas; and
a bipolar membrane positioned between the cathode and the anode, the bipolar membrane configured to facilitate water dissociation and ion transport between the cathode and the anode,
wherein the carbon monoxide produced at the cathode and the hydrogen gas produced at the anode combine to form syngas.

Clause 2: The electrochemical system of clause 1, wherein the carbon dioxide-containing feedstock comprises a bicarbonate solution.

Clause 3: The electrochemical system of clause 2, wherein the bicarbonate solution comprises potassium bicarbonate.

Clause 4: The electrochemical system of clause 1, wherein the organic compound comprises an aldehyde.

Clause 5: The electrochemical system of clause 4, wherein the aldehyde comprises formaldehyde.

Clause 6: The electrochemical system of clause 1, wherein the cathode comprises a nickel single-atom catalyst supported on carbon paper.

Clause 7: The electrochemical system of clause 1, wherein the anode comprises a copper-based electrode having mixed valence states of metallic copper and cuprous oxide.

Clause 8: The electrochemical system of clause 1, wherein the system is configured to operate at a current density of at least 200 mA cm⁻².

Clause 9: The electrochemical system of clause 1, wherein the system is configured to produce syngas having a hydrogen-to-carbon monoxide ratio between 1 and 2.

Clause 10: The electrochemical system of clause 1, further comprising:
a catholyte reservoir configured to store a catholyte solution comprising bicarbonate ions;
an anolyte reservoir configured to store an anolyte solution comprising the organic compound and hydroxide ions;
a catholyte pump configured to circulate the catholyte solution to the cathode; and
an anolyte pump configured to circulate the anolyte solution to the anode.

Clause 11: The electrochemical system of clause 1, wherein the anode is further configured to produce formate as a byproduct of the electrochemical oxidation of the organic compound.

Clause 12: A membrane electrode assembly for electrolytic syngas production, the membrane electrode assembly comprising:
a cathode comprising a catalyst configured to reduce bicarbonate to carbon monoxide;
an anode comprising a copper-based catalyst configured to oxidize an aldehyde to produce hydrogen gas and formate; and
a bipolar membrane disposed between the cathode and the anode, the bipolar membrane configured to generate protons at a cathode-facing side and hydroxide ions at an anode-facing side,
wherein the membrane electrode assembly is configured to produce syngas comprising the carbon monoxide from the cathode and the hydrogen gas from the anode.

Clause 13: The membrane electrode assembly of clause 12, wherein the cathode comprises a nickel single-atom catalyst.

Clause 14: The membrane electrode assembly of clause 12, wherein the copper-based catalyst comprises a mixed valence copper electrode having both metallic copper and cuprous oxide.

Clause 15: The membrane electrode assembly of clause 12, wherein the membrane electrode assembly is configured to operate at a cell voltage of 2.5 V or less at a current density of 200 mA cm⁻².

Clause 16: The membrane electrode assembly of clause 12, wherein the membrane electrode assembly is configured to achieve a combined Faradaic efficiency of approximately 200% for syngas production.

Clause 17: A method for electrolytically producing syngas, the method comprising:
supplying a bicarbonate solution to a cathode of an electrochemical cell;
supplying an aldehyde solution to an anode of the electrochemical cell;
applying a current to the electrochemical cell to electrochemically reduce bicarbonate at the cathode to produce carbon monoxide and to electrochemically oxidize the aldehyde at the anode to produce hydrogen gas; and
combining the carbon monoxide and the hydrogen gas to form syngas.

Clause 18: The method of clause 17, wherein the aldehyde solution comprises formaldehyde and potassium hydroxide.

Clause 19: The method of clause 17, wherein the electrochemical cell comprises a bipolar membrane separating the cathode and the anode, and wherein the bipolar membrane is operated in reverse-bias mode to generate a locally acidic environment at a cathode-membrane interface.

Clause 20: The method of clause 17, wherein the syngas has a hydrogen-to-carbon monoxide ratio between 1 and 2, and wherein the method further comprises directing the syngas to a Fischer-Tropsch reactor for conversion to hydrocarbons.

A number of implementations have been described. Nevertheless, it will be understood that various modifications may be made without departing from the spirit and scope of the disclosure. Accordingly, other implementations are within the scope of the following claims.

1. An electrochemical system for producing syngas, the system comprising:
a cathode configured to receive a carbon dioxide-containing feedstock and to electrochemically reduce carbon dioxide to produce carbon monoxide;
an anode configured to receive an organic compound and to electrochemically oxidize the organic compound to produce hydrogen gas; and
a bipolar membrane positioned between the cathode and the anode, the bipolar membrane configured to facilitate water dissociation and ion transport between the cathode and the anode,
wherein the carbon monoxide produced at the cathode and the hydrogen gas produced at the anode combine to form syngas.

2. The electrochemical system of claim 1, wherein the carbon dioxide-containing feedstock comprises a bicarbonate solution.

3. The electrochemical system of claim 2, wherein the bicarbonate solution comprises potassium bicarbonate.

4. The electrochemical system of claim 1, wherein the organic compound comprises an aldehyde.

5. The electrochemical system of claim 4, wherein the aldehyde comprises formaldehyde.

6. The electrochemical system of claim 1, wherein the cathode comprises a nickel single-atom catalyst supported on carbon paper.

7. The electrochemical system of claim 1, wherein the anode comprises a copper-based electrode having mixed valence states of metallic copper and cuprous oxide.

8. The electrochemical system of claim 1, wherein the system is configured to operate at a current density of at least 200 mA cm⁻².

9. The electrochemical system of claim 1, wherein the system is configured to produce syngas having a hydrogen-to-carbon monoxide ratio between 1 and 2.

10. The electrochemical system of claim 1, further comprising:
a catholyte reservoir configured to store a catholyte solution comprising bicarbonate ions;
an anolyte reservoir configured to store an anolyte solution comprising the organic compound and hydroxide ions;
a catholyte pump configured to circulate the catholyte solution to the cathode; and
an anolyte pump configured to circulate the anolyte solution to the anode.

11. The electrochemical system of claim 1, wherein the anode is further configured to produce formate as a byproduct of the electrochemical oxidation of the organic compound.

12. A membrane electrode assembly for electrolytic syngas production, the membrane electrode assembly comprising:
a cathode comprising a catalyst configured to reduce bicarbonate to carbon monoxide;
an anode comprising a copper-based catalyst configured to oxidize an aldehyde to produce hydrogen gas and formate; and
a bipolar membrane disposed between the cathode and the anode, the bipolar membrane configured to generate protons at a cathode-facing side and hydroxide ions at an anode-facing side,
wherein the membrane electrode assembly is configured to produce syngas comprising the carbon monoxide from the cathode and the hydrogen gas from the anode.

13. The membrane electrode assembly of claim 12, wherein the cathode comprises a nickel single-atom catalyst.

14. The membrane electrode assembly of claim 12, wherein the copper-based catalyst comprises a mixed valence copper electrode having both metallic copper and cuprous oxide.

15. The membrane electrode assembly of claim 12, wherein the membrane electrode assembly is configured to operate at a cell voltage of 2.5 V or less at a current density of 200 mA cm⁻².

16. The membrane electrode assembly of claim 12, wherein the membrane electrode assembly is configured to achieve a combined Faradaic efficiency of approximately 200% for syngas production.

17. A method for electrolytically producing syngas, the method comprising:
supplying a bicarbonate solution to a cathode of an electrochemical cell;
supplying an aldehyde solution to an anode of the electrochemical cell;
applying a current to the electrochemical cell to electrochemically reduce bicarbonate at the cathode to produce carbon monoxide and to electrochemically oxidize the aldehyde at the anode to produce hydrogen gas; and
combining the carbon monoxide and the hydrogen gas to form syngas.

18. The method of claim 17, wherein the aldehyde solution comprises formaldehyde and potassium hydroxide.

19. The method of claim 17, wherein the electrochemical cell comprises a bipolar membrane separating the cathode and the anode, and wherein the bipolar membrane is operated in reverse-bias mode to generate a locally acidic environment at a cathode-membrane interface.

20. The method of claim 17, wherein the syngas has a hydrogen-to-carbon monoxide ratio between 1 and 2, and wherein the method further comprises directing the syngas to a Fischer-Tropsch reactor for conversion to hydrocarbons.
